(19) United States
(12) Patent Application Publication
(10) Pub. No.: US 2013/0263791 A1
(43) Pub. Date: Oct. 10, 2013

(54) Fitted Absorbent Towel

(71) Applicant: Leslie Crisanaz, Milton, NH (US)

(72) Inventor: Leslie Crisanaz, Milton, NH (US)

(21) Appl. No.: 13/442,990

(22) Filed: Apr. 10, 2012

(51) Int. Cl. A01K 29/00

(52) U.S. Cl. 119/171

(57) ABSTRACT

The fitted, absorbent towel of the present invention is sized to slip over a pet table or crate tray and absorb liquid. The towel may be washable, reusable, disposable, and/or autoclavable. The pet tables include grooming and veterinary tables. The fitted, absorbent towels may comprise single or multiple layers of fabric, including, but not limited to natural and synthetic absorbent fabric layers, water-resistant or waterproof layers, padding layers, and the like. The fitted, absorbent towel may also include pockets, tabs and/or straps.

### FIELD OF THE INVENTION

The present invention relates to fitted, absorbent towels and more particularly to fitted absorbent towels for use with pet grooming and veterinary tables, or crate trays.

### BACKGROUND OF THE INVENTION

In the pet grooming and veterinary fields, animals are often placed on a table which is several feet off the ground. Having animals on tables makes them vulnerable to falls and injury from slipping. Placing animals on tables for examination, operating, or grooming can also cause the animal to become stressed. In the pet grooming context the animals are often secured with a lead and are therefore unable to see where they are placing their feet which increases the risk of slips and falls.

The risk of falling or slipping is increased when the table's surface is exposed to liquids. In the pet grooming context, the pet is also exposed to high-power dryers that can easily blow away towels or other lightweight items in the vicinity. Having the towels or other items used for grooming blown off the table risks injury to the worker, as they bend to retrieve the items, and also leaves the animal vulnerable to injury while they are momentarily unattended.

The risk to workers is also increased as the liquid accumulates on the table and begins to spill off of the table and onto the floor risking personal injury to workers and to those in the surrounding areas. It is also appreciated that in a veterinary context the liquids may be comprised of bodily fluids and the capture of these fluids by an absorbent material would be advantageous. Limiting the spread of liquids to surrounding areas minimizes clean up and potentially minimizes the transfer of disease.

Regardless of the type of liquid, the liquid damages the table tops which may be made from wood with a vinyl or laminate covering. By keeping the table tops dry, bacterial growth and other damage could be minimized. The risk of falling or slipping is further increased when the surface of the table is constructed of metal or other durable materials which are more easily cleaned. When the surface is smooth and easy to clean, it is also harder for a pet to get a grip and will become even more slippery when wet.

It is also important to note that animals are often uncomfortable or fearful when placed on a table for grooming or examination. This fear of falling or slipping can be minimized by providing a soft, absorbent, non-slip surface for the pets to stand or lie on. By alleviating stress for the animal the worker can avoid potential bites and the pets may exhibit less signs of stress making the treatment and/or grooming experience more pleasurable and effective.

Thus, there is a need for a fitted, absorbent towel for use on tables, such as tables used for pet grooming and veterinary applications.

### SUMMARY OF THE INVENTION

It has been recognized that there is a need for a fitted, absorbent towel for use on tables, such as for pet grooming and veterinary applications. The present invention will provide for a safer, more pleasant experience for pets needing to be groomed or examined by a vet. The present invention will also provide for increased worker safety by minimizing the spill of liquids and the transfer of disease, as well as other injuries associated with bending, bites, or other injuries. The present invention can also extend the life of the table by reducing damage caused by exposure to liquids.

One aspect of the present invention is a fitted, absorbent towel, comprising: at least one layer of absorbent fabric sized to slip over a pet table or crate tray, wherein the layer of fabric has a perimeter; and an elastic associated with the perimeter of the fabric thereby forming a fitted, absorbent towel configured to slip over a pet table or crate tray.

One embodiment of the fitted, absorbent towel is wherein the pet table is a grooming table.

One embodiment of the fitted, absorbent towel is wherein the elastic is sewn to the perimeter of the layer of absorbent fabric.

One embodiment of the fitted, absorbent towel is wherein the perimeter of the layer of absorbent fabric is sewn to create a channel into which the elastic is inserted.

One embodiment of the fitted, absorbent towel is wherein the layer of absorbent fabric is washable.

One embodiment of the fitted, absorbent towel further comprises a strap.

One embodiment of the fitted, absorbent towel is wherein the pet table is a veterinary table.

One embodiment of the fitted, absorbent towel is wherein the layer of absorbent fabric is autoclavable.

One embodiment of the fitted, absorbent towel is wherein the layer of absorbent fabric is disposable.

One embodiment of the fitted, absorbent towel is wherein the layer of absorbent fabric is water-resistant.

One embodiment of the fitted, absorbent towel is wherein the layer of absorbent fabric is waterproof.

Another aspect of the invention is a fitted, absorbent towel, comprising: a top layer of absorbent fabric sized to slip over a pet table or crate tray, wherein the layer of fabric has a perimeter; a second layer of fabric sized, to slip over a pet table or crate tray, wherein the second layer of fabric has a perimeter; and an elastic associated with the perimeter of at least one of the layers of fabric thereby forming a fitted, absorbent towel configured to slip over a pet table or crate tray.

One embodiment of the fitted, absorbent towel is wherein the pet table is a grooming table.

One embodiment of the fitted, absorbent towel is wherein the elastic is sewn to the perimeter of at least one of the layers of fabric.

One embodiment of the fitted, absorbent towel is wherein the perimeter of at least one of the layers fabric is sewn to create a channel into which the elastic is inserted.

One embodiment of the fitted, absorbent towel is wherein the layers of fabric are washable.

One embodiment of the fitted, absorbent towel is wherein the second layer of fabric is water-resistant.

One embodiment of the fitted, absorbent towel is wherein the second layer of fabric is waterproof.

One embodiment of the fitted, absorbent towel further comprises a strap.

One embodiment of the fitted, absorbent towel is wherein the pet table is a veterinary table.

One embodiment of the fitted, absorbent towel is wherein the layers of fabric are autoclavable.

One embodiment of the fitted, absorbent towel is wherein the layers of fabric are disposable.

Another aspect of the present invention is a fitted, absorbent towel, comprising: at least one layer of elastic, absorbent fabric sized to slip over a pet table or crate tray, wherein the layer of fabric has a perimeter and the perimeter is finished thereby forming a fitted, absorbent towel configured to slip over a pettable or crate tray.

One embodiment of the fitted, absorbent towel is wherein the pet table is a grooming table.

One embodiment of the fitted, absorbent towel is wherein the layer of absorbent fabric is washable.

One embodiment of the fitted, absorbent towel further comprises a strap.

One embodiment of the fitted, absorbent towel is wherein the pet table is a veterinary table.

One embodiment of the fitted, absorbent towel is wherein the layer of absorbent fabric is autoclavable.

One embodiment of the fitted, absorbent towel is wherein the layer of absorbent fabric is disposable.

One embodiment of the fitted, absorbent towel is wherein the layer of absorbent fabric is water-resistant.

One embodiment of the fitted, absorbent towel is wherein the layer of absorbent fabric is waterproof.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows an embodiment of a fitted, absorbent towel of the present invention.

FIG. 2 shows an embodiment of a fitted, absorbent towel of the present invention with pockets or tabs.

FIG. 3 shows an embodiment of a fitted, absorbent towel of the present invention comprising multiple layers of fabric.

FIG. 4 shows an embodiment of a fitted, absorbent towel of the present invention with a strap.

### DETAILED DESCRIPTION OF THE INVENTION

The fitted, absorbent towel of the present invention is designed to prevent liquid from accumulating on the top of a pet grooming table or pet examination and/or operating table. In addition to minimizing the accumulation of liquid on the table, the present invention minimizes the amount of liquid that can spill off of the tableland onto the floor creating a dangerous working condition. The liquid that is captured in the fitted, absorbent towel of the present invention will also lessen the potential for the spread of disease if the liquids comprise bodily fluids.

The fitted, absorbent towel of the present invention comprises at least one layer of absorbent fabric. In addition, the fitted, absorbent towel of the present invention may contain a liner comprised of a liquid barrier to further limit the leaching of liquids out of the towel and onto the floor. Absorbent fabrics include, but are not limited to wool, cotton, terry cloth, acrylic fabrics, fleece, velour, chenille, flannel, hemp, bamboo, synthetic fabrics, such as the 45% polyester/55% cellulose non-woven hydroentangled fabric sold by Invacare®, microfiber, polyester, and the like. The liquid barrier includes, but is not limited to, natural or synthetic fabrics that are laminated to or coated with a waterproofing material such as rubber, polyvinyl chloride (PVC), polyurethane (PU), silicone elastomer, flubropolymers, and wax, or fabrics which comprise a water-resistant or water-proof fabric, and the like. For example, PUL (polyurethane laminated fabric) would be particularly suited for veterinary applications. PUL provides the waterproof barrier needed in the medical field that can survive multiple institutional washings. The laminate can also be autoclaved, which is a very high heat steam sterilization process, to make it safe for reuse even after it comes into contact with blood or other bodily fluids. In addition to being absorbent, the fitted towel of the present invention may be washable. The fitted, absorbent towel of the present invention may be reusable or disposable. The fitted, absorbent towel of the present invention may be autoclavable.

The fitted, absorbent towel of the present invention has been designed to stretch over the top of various sized tables, including, but not limited to, pet grooming and veterinary examination and/or operating tables. When describing the length and width of the towels of the present invention, the dimensions represent the corresponding dimensions that describe the length and width of the tables for which the towels will be used. It is appreciated that additional fabric may be used to envelope the table and thus this additional fabric may extend underneath the table by varying amounts. It is also appreciated that the table may be any shape, including but riot limited to, round, oval, rectangle, trapezoidal, or square.

In one embodiment, the length of the fitted, absorbent towel is from about 12 inches to about 60 inches. In one embodiment, the length of the fitted, absorbent towel is from about 18 inches to about 54 inches. In one embodiment, the length of the fitted, absorbent towel is from about 24 inches to about 48 inches. In one embodiment, the length the fitted, absorbent towel is from about 30 inches, to about 42 inches. In one embodiment, the length of the fitted, absorbent towel is about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, or about 30 inches. In one embodiment, the length of the fitted, absorbent towel is about 31 inches, about 32 inches, about 33 inches, about 34 inches, about 35 inches, about 36 inches, about 37 inches, about 38 inches; about 39 inches, about 40 inches, about 41 inches, about 42 inches, about 43 inches, about 44 inches, about 45 inches long, about 46 inches long, about 47 inches long, about 48 inches long, or about 49 inches long. In one embodiment, the length of the fitted, absorbent towel is about 50 inches, about 51 inches, about 52 inches, about 53 inches, about 54 inches, about 55 inches, about 56 inches, about 57 inches, about 58 inches, about 59 inches, of about 60 inches.

In one embodiment, the width of the fitted, absorbent towel is: from about 12 inches to about 60 inches. In one embodiment, the width of the fitted, absorbent towel is from about 18 inches to about 54 inches. In one embodiment, the width of the fitted, absorbent towel is from about 24 inches to about 48 inches. In one embodiment, the width the fitted, absorbent towel is from about 30 inches to about 42 inches. In one embodiment, the width of the fitted, absorbent towel is about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, or about 30 inches. In one embodiment, the width of the fitted, absorbent towel is about 31 inches, about 32 inches, about 33 inches, about 34 inches, about 35 inches, about 36 inches, about 37 inches, about 38 inches, about 39 inches, about 40 inches, about 41 inches, about 42 inches, about 43 inches, about 44 inches, about 45 inches long, about 46 inches long, about 47 inches long, about 48 inches long; or about 49 inches long. In one embodiment, the width of the fitted, absorbent towel is about 50 inches, about 51 inches, about 52 inches, about 53 inches, about 54 inches, about 55 inches, about 56 inches, about 57 inches, about 58 inches, about 59 inches, or about 60 inches.

The fitted, absorbent towel of the present invention may be comprised of one or more layers of fabric. Each layer of fabric may be quilted or not, and the layers of fabric may or may not be. quilted together depending on the application. The multiple layers may also be associated in such a way as to form a composite fabric resembling a single layer of fabric. Where the fitted, absorbent towel of the present invention comprises a plurality of layers of fabric, each layer may be made of the same type or different type of fabric from the other layers.

In one embodiment, the fitted, absorbent towel comprises from about 1 layer to about 10 layers of fabric. In one embodiment, the fitted, absorbent towel comprises from about 2 layers to about 9 layers of fabric. In one embodiment, the fitted, absorbent towel comprises from about 3 layers to about 8 layers of fabric. In one embodiment, the fitted, absorbent towel comprises from about 4 layers to about 7 layers of fabric. In one embodiment, the fitted, absorbent towel comprises about 1 layer, about 2 layers, about 3 layers, about 4 layers, about 5 layers, about 6 layers, about 7 layers, about 8 layers, about 9 layers or about 10 layers of fabric.

There may also be pockets, or tabs, sewn into or onto tor the fitted, absorbent: towel that could be used to hold tools, treats, and the like. The pockets, or tabs, could be located under the edge of the table for ease of use. Furthermore, the pockets could be removable and moveable when constructed using a Velrco® attachment, and the like.

When a pet is being groomed, a towel is often placed under the pet when drying the pet on a grooming table. A normal towel will blow off the table since there is nothing to keep it in place. The design of the fitted, absorbent towel of the present invention makes certain that it stays in place. A regular towel cannot stay in place on a grooming table without the use of clamps or some other means to secure it. While clamps may hold a towel in place, there is an added risk of injury to the pet when anything additional is on the table with them. Clamping a towel in place also takes time. Even when using clamps to secure the towel to the table, every table and towel is a different size and not every towel even reaches to the edges of the table to be used with a securing device. The clamp also poses a hazard to the pet who may step on its sharp/hard edges resulting in a negative experience or even injury. The clamp may also present injury to the worker if they bump into it while moving around the table when working.

The fabric of the fitted absorbent towel of the present invention provides a secure feeling under the pet's feet making their experience on the table better. This is especially effective for elderly pets. Furthermore, the fitted, absorbent towel of the present invention can be used to keep things in place on the table. For instance, if you are grooming or examining an elderly pet that needs extra cushioning under them, you can use the towel on top to keep that cushion from shifting. Additionally, one of the layers of the towel could comprise additional cushioning for comfort or added absorbency.

Due to the fact that this fitted, absorbent towel is made to stretch over the table top, it holds everything in place without the use of clamps which often ruins “the look” at dog or cat shows. The fitted, absorbent towel of the present invention may also be aesthetically pleasing and used to give a grooming table at a dog or cat show a more complete look. The fitted, absorbent towel of the present invention can be decorated, and/or embroidered to represent institutions or companies including, but not limited to, teaching hospitals, veterinary clinics, kennels, and the like. The fitted, absorbent towel of the present invention may also be comprised of fabrics in a variety of colors.

The fitted, absorbent towel of the present invention may also be used to cover crate/trays. Animal crates are currently available in many sizes and shapes. Often the pet crates have removable trays to catch liquid and to provide a solid base, such as in a metal wire crate. The crate tray cover application would provide absorbency, cushioning, and a more aesthetically appealing look to the pet crate while making the pet more comfortable. As with the other applications discussed herein, the fabric choice for the fitted, absorbent towel of the present invention can provide a range of properties depending on the application, including, but not limited to washable, reusable, autoclavable, and the like. As discussed previously with respect to tables, the dimensions for the fitted, absorbent towel of the present invention refer to lengths and widths of fabric that refer to the crate tray for which the fitted, absorbent towel of the present invention will be used.

It is understood that grooming tables and water do not mix. When grooming a pet, it is customary to put a towel under the wet pet when drying them on the table. But, the towels will blow off while drying the pet and the worker is then forced to bend over and pick up the towel constantly in order to keep the water coming off of the pet from puddling on the table top. The water that flows off of the pet and into the fitted, absorbent towel allows pets to be dried more efficiently without having to constantly pick a towel up off the floor. It also provides better footing for elderly pets. The accumulation of water makes the table top slippery and slows down the drying process. The fitted, absorbent towel of the present invention keeps the table top dry and provides footing for the pet which, in turn, makes the entire grooming experience more enjoyable. Most importantly, the towel is designed to slip over the table so it does not fly off when using a high velocity dryer on the pet.

The fitted, absorbent towel of the present invention has been designed to stretch over pet grooming table tops and veterinary examination and operating table tops with an elastic mechanism. The fitted, absorbent towel stays in place without any additional means of securing so that a worker does not have to bend over constantly and pick a towel up off of the floor, or risk slipping and falling during the interaction with the pet on the table. The lack of additional securing mechanisms also allows for free movement around the table for both the pet and the worker such that risk of injury from clamps is minimized. The fitted, absorbent towel stretches around any posts that may be attached to the table such as grooming arms or arms for attaching intravenous or other medical equipment during a veterinary examination or operation.

For the present invention, “elastic” means any flexible device that will return to its original shape when stretched or capable of adapting (of becoming or being made suitable) to a particular situation or use. For example, “elastic” could mean a narrow band of elastic rubber used to hold things together; a thin flat strip of flexible material; a fabric made of yarns containing ah elastic material; cloth, fabric, textile, material such as is made by weaving or felting or knitting or crocheting natural or synthetic fibers. Elastic could also represent a stretchable cord, or some other component which enables the towel to be fitted around a particular shape. It is also appreciated that certain fabrics are elastic in nature and may not need any additional elastic component to envelope the tables as described herein.

The fitted, absorbent towel of the present invention is constructed by first measuring the table top or crate tray that you are making the towel for. Then, the type or types of fabric are selected for the particular application. Once the fabric or fabrics have been chosen, the fabric is cut to the specified size. At this point, the fabric will be attached to elastic, if necessary, in any number of ways. The elastic may be stitched, glued or otherwise attached to the fabric to provide a fitted, absorbent towel.

Some ways of stitching the elastic to the fabric layer or layers includes, but is not limited to the following: the fabric and the elastic are sewn together in one step using a flat-lock (serger) sewing machine and thread; instead of finishing the edge of the fabric and applying the elastic simultaneously, you could fold over and secure the edge of the fabric before attaching the elastic, or create a channel at the edge of the fabric for the elastic or an adjustable cording to run through.

The fitted, absorbent towel of the present invention is stretched over the top of the table and around or over any clamps or posts that may be on the table. It will not blow off when forced air drying a pet and will absorb water which will hasten the drying process.

This invention could also be used on veterinary examination or operation tables to make the pet feel more comfortable and absorb any fluids which may be present. The fitted, absorbent towel of the present invention could be washable and/or autoclavable to provide a clean and/or sterile cover for tables used in veterinary applications. The use of such towels could also be economical and ecologically beneficial additions to the pet industry.

The fitted, absorbent towel of the present invention is contemplated to work well with various forms of pet tables including both portable and non-portable tables. The present invention requires the table to have a slight lip for which the fitted, absorbent towel envelopes in order to stay in place when in use. There are numerous types of pet tables known to those skilled in the art. For the sake of simplicity only a few are listed herein, and they include, tables with a hydraulic lift, tables with pedestals, tables with legs that may or may not fold under the table, collapsible tables, tables that fold up or down for transport and/or storage, tables built onto cabinets that may or may not extend beyond the cabinet or shelving below, arid the like.

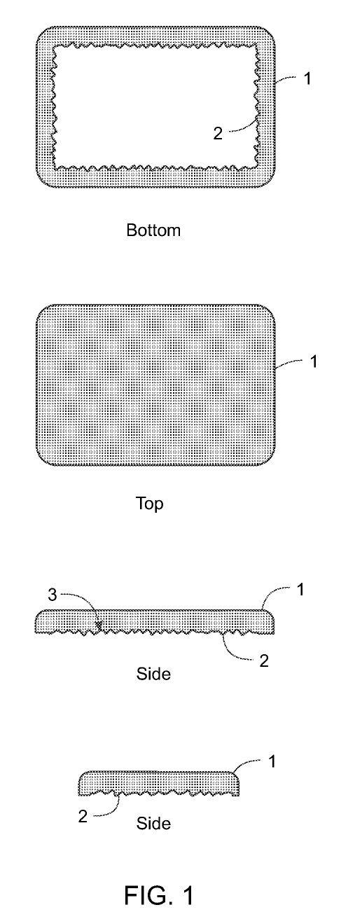

Referring to FIG. 1, one embodiment of the fitted, absorbent towel of the present invention is shown. More particularly, a top view and several bottom views are shown. The top view of the fitted, absorbent towel 1 is shown. The top layer of the fitted, absorbent towel comprises an absorbent fabric. It is understood that the fitted, absorbent towel 1 may only contain one layer of fabric. The bottom view of the fitted, absorbent towel 1 is shown where the portion of the towel that extends below the table 2 is shown as well. The portion that extends below the table 2 secures the towel in place and can vary in dimensions. The edge 3 of the portion that extends below the table 2 can also be finished or rough sown. The edge 3 may contain additional elastic components (not shown) attached to the portion that extends below the table 2 or may be inserted into a channel created in the fabric of the fitted, absorbent towel of the present invention.

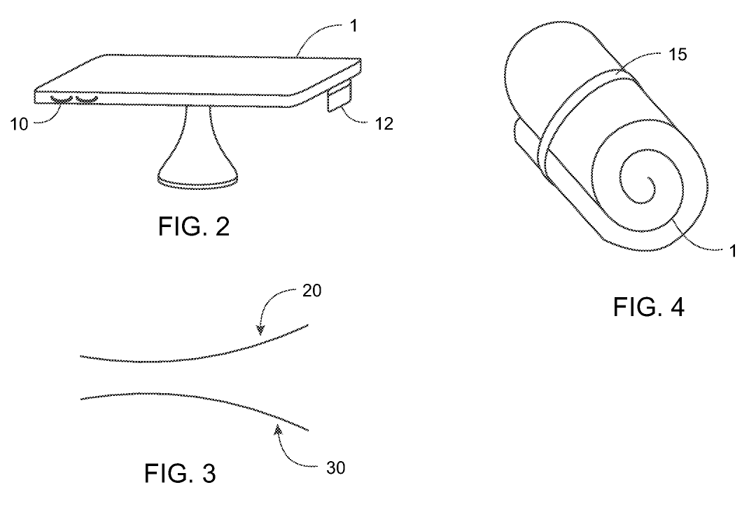

Referring to FIG. 2, one embodiment of the fitted, absorbent towel of the present invention is shown. More particularly, the fitted, absorbent towel 1 is shown with tabs 10 and a pocket 12 attached, to the fitted, absorbent towel of the present invention. The location of the tabs 10 and/or pocket 12 can vary and may be placed on the edge or underneath the edge of the table depending on the application.

Referring to FIG. 3, one embodiment of the fitted, absorbent towel of the present invention is shown. More particularly, the fitted, absorbent towel of the present invention is shown comprising at least two separate layers. The top layer 20 and the bottom layer 30. The top most layer, or the single layer in the embodiment where there is only one layer, is comprised of an absorbent fabric. The bottom layer 30, or any additional internal layers (not shown) can be comprised of absorbent fabrics, water-resistant and/or waterproof layers, or even padded layers depending oh the application. Additionally, the multiple layers can essentially form a composite fabric resembling a single layer.

Referring to FIG. 3, one embodiment of the fitted, absorbent towel 1 of the present invention is shown. More particularly, the fitted, absorbent towel 1 of the present invention is shown in a rolled orientation for storage or transport. Also shown, is a strap 15 used to keep the towel rolled. The strap 15 could be made of elastic or non-elastic material and can be separate, or attached to the fitted, absorbent towel of the present invention for ease of use.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A fitted, absorbent towel, comprising:
at least one layer of absorbent fabric sized to slip over a pet table or crate tray, wherein the layer of fabric has a perimeter; and
an elastic associated with the perimeter of the fabric thereby forming a fitted, absorbent towel configured to slip over a pet table or crate tray.

2. The fitted, absorbent towel of claim 1, wherein the pet table is a grooming table.

3. The fitted, absorbent towel of claim 1, wherein the elastic is sewn to the perimeter of the layer of absorbent fabric.

4. The fitted, absorbent towel of claim 1, wherein the perimeter of the layer of absorbent fabric is sewn to create a channel into which the elastic is inserted.

5. The fitted, absorbent towel of claim 1, wherein the layer of absorbent fabric is washable.

6. The fitted, absorbent towel of claim 1, further comprising a strap.

7. The fitted, absorbent towel of claim 1, wherein the pet table is a veterinary table.

8. The fitted, absorbent towel of claim 7, wherein the layer of absorbent fabric is autoclavable.

9. The fitted, absorbent towel of claim 7, wherein the layer of absorbent fabric is disposable.

10. The fitted, absorbent towel of claim 1, wherein the layer of absorbent fabric is water-resistant.

11. The fitted, absorbent towel of claim 1, wherein the layer of absorbent fabric is waterproof.

12. A fitted, absorbent towel, comprising:
a top layer of absorbent fabric sized to slip over a pet table or crate tray, wherein the layer of fabric has a perimeter;
a second, layer of fabric sized to slip over a pet table or crate tray, wherein the second layer of fabric has a perimeter; and
an elastic associated with the perimeter of at least one of the layers of fabric thereby forming a fitted, absorbent towel configured to slip over a pet table or crate tray.

13. The fitted, absorbent towel of claim 12, wherein the pet table is a grooming table.

14. The fitted, absorbent towel of claim 12, wherein the elastic is sewn to the perimeter of at least one of the layers of fabric.

15. The fitted, absorbent towel of claim 12, wherein the perimeter of at least one of the layers, fabric is sewn to create a channel info which the elastic is inserted.

16. The fitted, absorbent towel of claim 12, wherein the layers of fabric are washable.

17. The fitted, absorbent towel of claim 12, wherein the second layer of fabric is water-resistant.

18. The fitted, absorbent towel of claim 12, wherein the second layer of fabric is waterproof.

19. The fitted, absorbent towel of claim 12, further comprising a strap.

20. The fitted, absorbent towel of claim 12, wherein the pet table is a veterinary table.

21. The fitted, absorbent towel of claim 20, wherein the layers of fabric are autoclavable.

22. The fitted, absorbent towel of claim 20, wherein the layers of fabric are disposable.

23. A fitted, absorbent towel, comprising:
at least one layer of elastic, absorbent fabric sized to slip over a pet table, wherein the layer of fabric has a perimeter and the perimeter is finished thereby forming a fitted, absorbent towel configured to slip over a pet table or crate tray.

24. The fitted, absorbent towel of claim 23, wherein the pet table is a grooming table.

25. The fitted, absorbent towel of claim 23, wherein the layer of absorbent fabric is washable.

26. The fitted, absorbent towel of claim 23, further comprising a strap.

27. The fitted, absorbent towel of claim 23, wherein the pet table is a veterinary table.

28. The fitted, absorbent towel of claim 27, wherein the layer of absorbent fabric is autoclavable.

29. The fitted, absorbent towel of claim 27, wherein the layer of absorbent fabric is disposable.

30. The fitted, absorbent towel of claim 23, wherein the layer of absorbent fabric is water-resistant.

31. The fitted, absorbent towel of claim 23, wherein the layer of absorbent fabric is waterproof.
